(19) United States
(12) Patent Application Publication
(10) Pub. No.: US 2007/0166226 A1
(43) Pub. Date: Jul. 19, 2007

(54) Process for preparing mesoporous materials

(76) Inventors: Justin Derek Holmes, Corrigaline (IE); Kaixue Wang, Cork (IE); John Paul Hanrahan, Clonmel (IE); Michael Anthony Morris, Midleton (IE); Trevor Richard Spalding, Cork (IE)

Correspondence Address: JACOBSON HOLMAN PLLC, 400 SEVENTH STREET N.W., SUITE 600, WASHINGTON, DC, 20004, US

(21) Appl. No.: 11/578,370

(22) PCT Filed: Apr. 13, 2005
(86) PCT No.: PCT/IE05/00042

§ 371 Date: Oct. 13, 2006

Related U.S. Application Data
(60) Provisional application No. 60/561,533, filed on Apr. 13, 2004.

(51) Int. Cl. B01J 8/02

(52) U.S. Cl. 423/659

(57) ABSTRACT

A process for preparing a mesoporous material comprises the step of preparing a sol and treating the sol material under supercritical fluid conditions. The treatment under supercritical fluid conditions forms an ordered mesoporous material. The sol may be applied to a substrate to form a mesoporous film and subsequently treating the film under supercritical fluid conditions. Alternatively the process may comprise directly treating the sol under supercritical fluid conditions to form a mesoporous powder material.

### FIELD OF THE INVENTION

The present invention relates generally to the manufacture of mesoporous materials.

### BACKGROUND OF THE INVENTION

Ordered mesoporous materials, such as and usually mesoporous silica (SiO₂), consist of arrangements of pores with uniform diameter and structure. The size of these mesopores, and the spacing between the pores can range between a few to tens of nanometers. The preparation of mesoporous materials, both powders and thin films, can usually be described as being template assisted. In a typical process surfactant molecules, ionic or non-ionic, which aggregate in aqueous solution to form micelles and/or various liquid crystal phases can be used as templates for forming mesoporous elemental oxides. Under the correct conditions a suitable inorganic compound (which can be described as a precursor as it supplies the cations into the inorganic mesoporous framework) is hydrolysed and condensed around the organic surfactant template to form an inorganic-organic hybrid material. Careful removal of the organic component, by calcination and/or chemical extraction, results in a mesoporous inorganic elemental oxide material with high surface area. To prepare mesoporous thin films the mixture of inorganic precursor and organic template is applied to a substrate prior to condensation of the elemental oxide. Careful calcination yields a solid mesoporous film.

Silica (SiO₂) is the easiest material to prepare in both powder and film form. In preparing SiO₂ films great care has to be taken over the process variables, such as choice of precursor (the source of cations in the mesoporous framework) materials, reactant concentrations, reaction temperatures, reaction time, application method and conditions, thickness of applied film, drying temperature, drying time, calcination temperature, calcination time etc., to produce stable materials exhibiting high pore order within the film. Preparing mesoporous films of other materials, for example silica doped with other cations such as titania (TiO₂), zirconia (ZrO₂), ceria (CeO₂), and hafnium oxide (HfO₂) is difficult compared to powders due to the rapid hydrolysis of the oxide precursors and crystallisation of the films as a poorly defined agglomeration of particles with no long range ordered mesoporosity.

For many commercial applications of mesoporous films, processing the inorganic precursor material as a highly thermal stable coating or thin film is essential. However, the thermal treatment typically employed to remove organic components and importantly densify the poorly defined inorganic walls surrounding the organic template can lead to a total collapse of the templated ordered mesoporous network. This is particularly true for ordered mesoporous material synthesis of solids other than silica.

It is advantageous to make mesoporous titania thin films due to their application in photochromic and photovoltaic cells, photo-catalysed bio-degradation surface coatings, gas sensors and photonic band gap materials amongst others. However, attempts to prepare mesoporous titania materials using simple hydrolysis and condensation reactions have resulted in products of low thermal robustness. As a result, attempts have been made to increase the thermal stability of mesoporous titania materials using several post-synthesis calcination methods. For powder synthesis, the most thermally stable materials seem to have been produced by Cassiers et al [1] who reported that the post-treatment of uncalcined mesoporous titania powder with ammonia resulted in the formation of mesoporous crystalline titania with thermal stability up to 600° C. However, it is not clear in their work that the materials produced have significant long range order. The most stable films made to date were synthesised by Sanchez and Grosso et al [2] who employed the evaporation-induced self-assembly (EISA) method for the preparation of high-quality mesoporous TiO₂ thin films. This involved synthesizing a film followed by low temperature calcination (500° C.) and then applying a short post-synthesis treatment involving short time exposure to 730° C. which they described as “delayed rapid crystallization”. This resulted in materials that were claimed to have long term thermal stability to temperatures of 500° C. However, the products have only limited long range order as they are formed by partial collapse of a long-range ordered mesoporous structure.

There is therefore a need for an improved process for manufacturing mesoporous thin film materials which will address these problems.

### STATEMENTS OF INVENTION

According to the invention there is provided a process for preparing a mesoporous material comprising the step of preparing a sol and treating the sol material under supercritical fluid conditions. The treatment under supercritical fluid conditions forms an ordered mesoporous material.

In one embodiment the mesoporous material is a mesoporous film. In this case the process may comprise applying the sol to a substrate to form a mesoporous film and subsequently treating the film under supercritical fluid conditions.

In another embodiment the mesoporous material is a mesoporous powder. In this case the process may comprise directly treating the sol under supercritical fluid conditions to form a mesoporous powder material.

In one embodiment the sol material is treated under supercritical fluid conditions in the presence of a silating agent. The silating agent may be selected from a silicon containing material which can be decomposed to form silica during the supercritical fluid treatment. The silating agent may be a silicon alkoxide or an organic silane. The silating agent may be tetramethyloxysilane or tetramethylsilane.

In one embodiment the sol material is treated under supercritical fluid conditions in the presence of a titanating agent. The titanating agent may be selected from a titanium containing material which can be decomposed to form titania during the supercritical fluid treatment. The titanating agent may be a titanium alkoxide. The titanating agent may be titanium tetra isopropoxide or titanium tetra isobutoxide.

In another embodiment the supercritical fluid is selected from any one or more of carbon dioxide, propane, ethane, butane, pentane, hexane, ammonia and water.

The process may be carried out at temperatures up to 500° C. in the presence of a silating agent or titanating agent or similar inorganic compound. The supercritical fluid treatment may be carried out at a pressure greater than the critical pressure of the fluid and the temperature is less than 20° C. less than the critical temperature of the fluid.

In one embodiment after treatment with supercritical fluid, the mesoporous material is calcined in air or air-ozone mixtures at temperatures between 200 and 1000° C.

In one embodiment the sol comprises a surfactant template, a elemental oxide precursor inorganic compound, a catalyst, and a solvent. The precursor inorganic compound may be a hydrolysable compound as the source of cations in the final mesoporous oxide framework. The precursor compound may be a compound selected from any one or more of of Si, Al, Ti, Zr and W. The precursor compound may be an alkoxide or a chloride. The precursor compound may also include an alkoxide or chloride of boron, lanthanum, yttrium and hafnium.

In one case the solvent is an alcohol which may be selected from one or more of ethanol, methanol, 1-propanol, 2-propanol and 1-butanol.

In one embodiment the catalyst is an acid catalyst. The acid may be selected from one or more of hydrochloric, nitric, sulfuric, phosphoric, hydrofluoric, acetic and citric acid. In another embodiment the surfactant is selected from the group consisting of triblock copolymers of polyethylene (PEO), polypropylene (PPO), polyalkyloxide materials, polyoxyethylene alkyl ethers and anionic or cationic surfactants consisting of alkyl chains and ionic head groups such as cetyl trimethyl ammonium bromide.

In one embodiment the sol is a prepared by heating a sol mixture to a temperature between −4° C. and 80° C. for up to 2 hours.

The process may comprise cooling the sol and controlling the amount of water to a temperature between −4° C. and 25° C. to effect the production of a partially hydrolysed product prior to adding a secondary inorganic precursor compound to effect cross condensation processes.

In one embodiment the prepared sol is allowed to stand for a period at a temperature between 0° C. and 80° C.

The sol material may be applied to a substrate by spin or dip coating. The film may be dried in defined stages at temperatures between 20 and 200° C.

The surfactant may be selected to control the pore size of the mesoporous material. The pressure of the supercritical fluid and the temperature thereof may be selected to control the pore size of the mesoporous material.

The invention provides an ordered mesoporous material whenever prepared by a process of the invention. The material may be an ordered mesoporous film material or an ordered mesoporous powder material.

In another aspect the invention provides a mesoporous material having an ordered array of pores. The pore diameter may be from 1 to 30 nm, preferably between 1 and 15 nm and generally between 1 and 5 nm.

The ordered mesoporous material may be in the form of a film or in the form of a powder. The mesoporous material may be formed by an elemental oxide.

The invention provides an easy and reproducible process to prepare high-quality elemental oxide films of elemental oxides (including silica, titania, zirconia, doped silicas and many other elemental oxides) on substrates by spin-coating and post-treatment of the film in supercritical carbon dioxide (sc-CO₂) carbon dioxide. With the synthesis method of the invention it is possible to prepare crystalline and amorphous films of elemental oxides with enhanced thermal robustness. We have shown that thermally stable long range ordered mesoporous films stable in air to temperatures of up to 600° C. may be prepared. Further, well-defined mesoporous films with less well-defined order and thermally stable to 850° C. may also be prepared.

The present invention provides a method for forming a porous elemental oxide film having an ordered array of pores whose diameter is between 1 and 30 nm, usually 1 to 15 nm, and generally 1 to 5 nm. The porous elemental oxide formed exhibits increased thermal stability compared to conventionally prepared mesoporous films. By careful control of the reaction conditions and the amount and type of surfactant used, the pore size and structure of the mesoporous layers may be predetermined.

The invention provides well-ordered thermally stable ordered mesoporous films showing significantly less macroscopic cracking than more conventionally processed materials. The invention is particularly suited to the preparation of thermally stable films of elemental oxides which, because of their chemical properties, are difficult to form or are prone to pore collapse at low temperatures.

### BRIEF DESCRIPTION OF THE DRAWINGS

The invention will be more clearly understood from the following description thereof, given by way of example only, with reference to the accompanying drawings, in which:

FIG. 1 is a flow diagram illustrating a process according to the invention;

FIG. 2 is a graph showing PXRD (powder x-ray diffraction) patterns of (A) (left) untreated and (B) (right) supercritical carbon dioxide (sc-CO₂)/TMOS-treated mesoporous titania thin films calcined at various temperatures for a duration of one hour each;

FIG. 3 are transmission electron microscopy (TEM) images of the sc-CO₂/TMOS-treated titania films after calcination at (A) temperatures below 600° C. and (B) temperatures above 600° C.;

FIG. 4 is a scanning electron microscopy (SEM) image of the sc-CO₂/TMOS-treated titania films after calcination at 750° C. No physical cracking of the surface can be seen;

FIG. 5 is a graph showing PXRD (powder x-ray diffraction) patterns of sc-CO₂/TMOS-treated mesoporous silica films calcined at various temperatures for duration of one hour each;

FIG. 6 is a graph showing Low-angle XRD patterns of (a) mesoporous zirconia thin film post-treated by sc-CO₂/TMOS (treated at 150° C.) and those then calcined at (b) 450, (c) 750, (d) 850, and (e) 950° C. after the post-treatment. As can be seen porosity is maintained to temperatures of 850° C.;

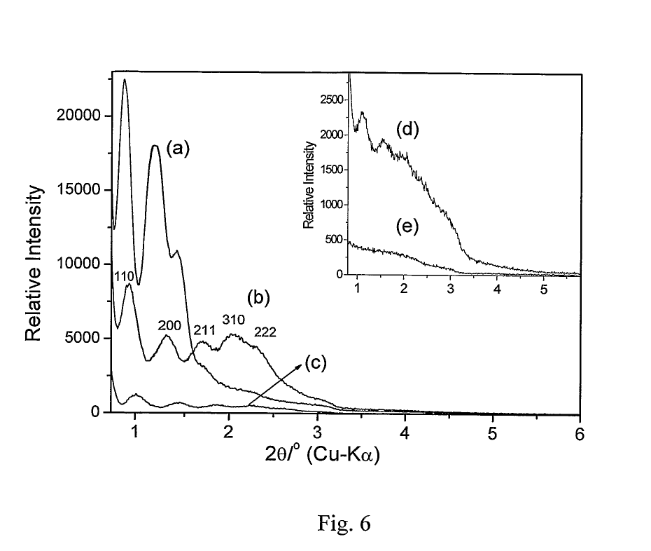

FIG. 7 are TEMs of (a) mesoporous zirconia thin film treated by sc-CO₂/TMOS and those then calcined at (b) 450, and (c) 750° C. after the post-treatment. (d) high resolution electron micrograph of (c) showing the crystalline grains of tetragonal zirconia; and

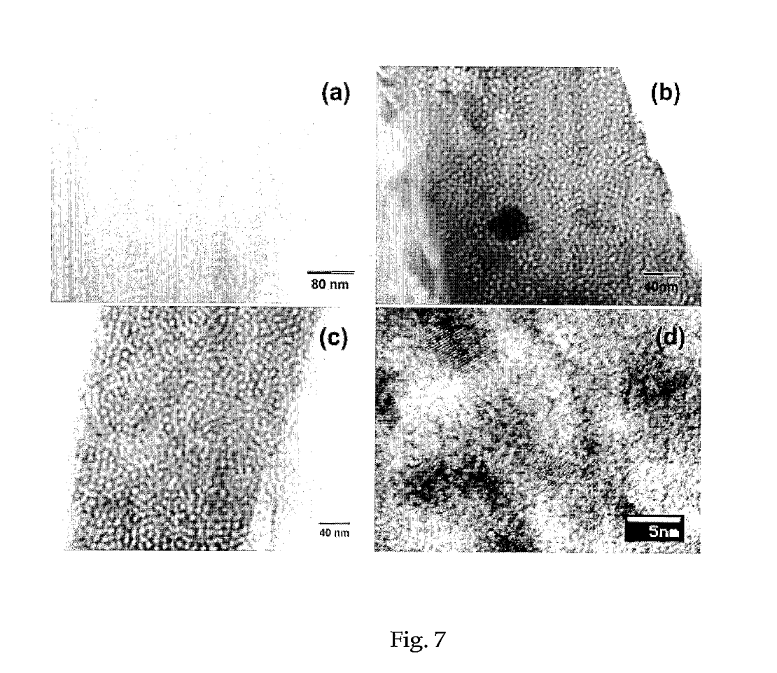

FIG. 8 is a graph showing the IR spectra of a stearic acid layer as a function of time under UV illumination at a wavelength of 254 nm.

### DETAILED DESCRIPTION

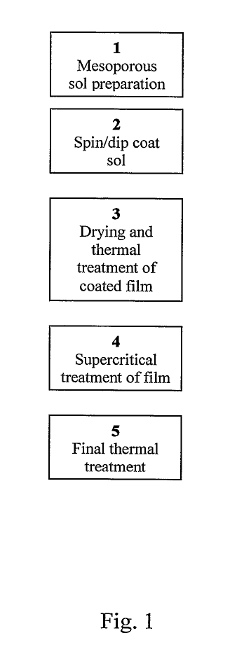

FIG. 1 is a flow diagram showing a process in accordance with the present invention, illustrating a general method of forming ordered mesoporous elemental oxide films. First, a elemental oxide sol is prepared as illustrated by block 1. The sol-gel is then deposited onto a substrate to form a film, as illustrated by block 2. Then, as illustrated in block 3, the as-deposited film is dried and densified. The film is processed in a supercritical fluid and in the presence of a secondary precursor material such as a silating, titanating or similar agent (block 4) to yield an ordered mesoporous thin film with robust pore structure. Finally, as illustrated in block 5, the film is calcined to create an organic free mesoporous oxide film.

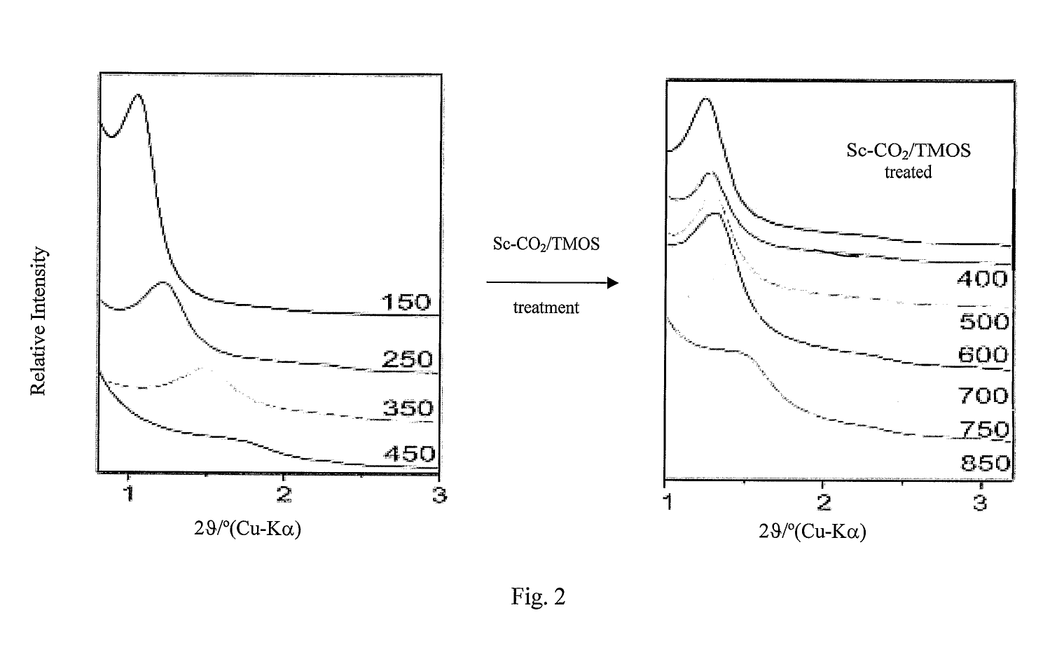

FIG. 2 illustrates the beneficial effect of the sc-CO₂/TMOS treatment. Low angle powder x-ray diffraction (PXRD) data at angles between 0 and 5 degrees 2 theta are an indication of mesoporosity as ordered mesoporous samples show a well-resolved feature in this range. If a sample of substrate coated material prior to the sc-CO₂ treatment is compared to a similar sample after the sc-CO₂ treatment, the additional thermal robustness of the sc-treated film is easily observed. In the untreated film pore collapse is initiated at 350° C. (as indicated by the loss of intensity and movement of the peak) and completed by 450° C. when the XRD feature is absent. The sc-CO₂/TMCS treated sample shows no structural change until heated to temperatures in excess of 600° C. some 250° C. higher than the untreated sample. There is some structural change above this temperature that is explained by coalescence of some of the pores, but significant porosity is retained to thermal processing at 850° C. The sample retains mesoporosity when heated to 800° C. for 48 hours.

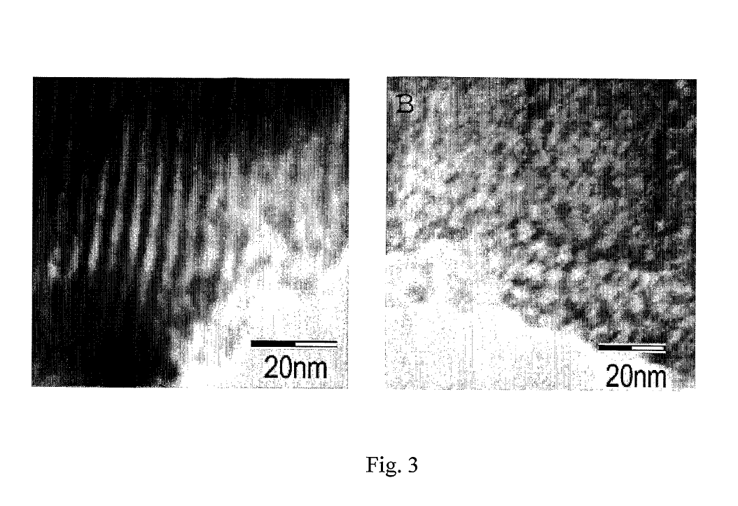

FIG. 3 displays TEM images which show the mesoporous structure of the titania film produced is highly ordered until thermal processing temperatures of 600° C. (FIG. 3A). Above this process temperature the pore restructuring leads to a less ordered phase with larger pores (FIG. 3B).

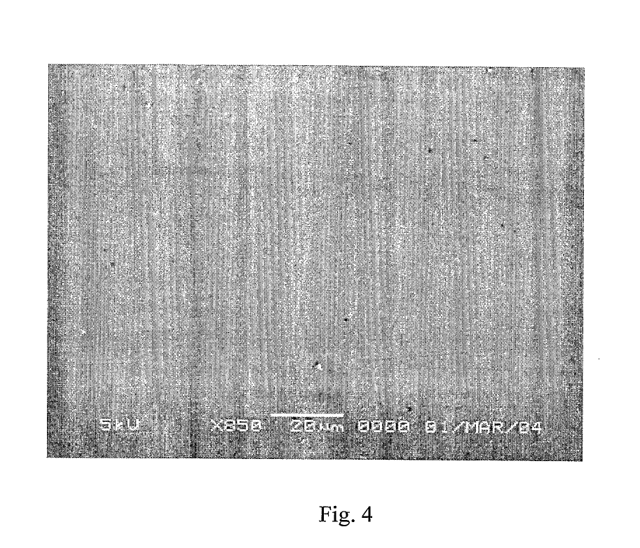

FIG. 4 shows a secondary electron microscope image of the films as described herein. The film is free of any macroscopic cracks due to sc-CO₂/TMOS process which prevents film shrinkage and the stresses associated with crack formation during synthesis.

Terminology

We define an ordered mesoporous structure as one in which the pores are arranged in an ordered arrangement with symmetry described as hexagonal, cubic or lamellar arrangement. In this way an ordered mesoporous structure is not the same as a random mesoporous formed from tortuous mesopores resulting for example from trapped volumes between particles in a solid. The ordered mesoporous structures formed here are similar to materials previously described using the acronyms MCM [Mobil Composition of Matter] or SBA [Santa Barbara]. We define the organic template as a defined regular structural arrangement originating from the assembly of surfactant molecules in a solvent as defined by the solvent-surfactant interactions. The organic template can also be described as a structural directing agent (SDA). A typical surfactant is a triblock copolymer of polyethylene (PEO) and polypropylene (PPO) with a chemical formula of PEO₆₀PPO₂₀PEO₆₀. The inorganic precursor is a chemical compound that can be reacted with other chemical compounds to produce an oxide material. The oxide material will form around the organic template structure to form an inorganic oxide skeleton which will survive treatments to remove the organic component. The inorganic element, or elements of the precursor may be from the Main Group or the Transition series of the Periodic Table. Typically, these may be silicon, boron, titanium, zirconium, hafnium, or cerium. The most likely (but not necessarily the only) precursor is a suitable elemental alkoxide compound such as tetraethyl orthosilicate or titanium tetra isopropoxide or elemental halides such as silicon tetrachloride or titanium tetrachloride. The precursor (in the presence of surfactant and solvent and other materials) is treated with water and a hydrolysis catalyst to yield molecules and molecular assemblies containing hydroxide groups. These hydroxyl group containing species react by eliminating water or HX (X=OR or halide) to produce -M-O-M- (M representing a cation and O and oxygen ion) bonds, by what is known as a condensation reaction. The product of the condensation reaction is a poor chemically, structurally and stoichiometrically defined solid or gel containing elemental oxide, hydroxide and inorganic-organic bonds. Cross-condensation is a term which implies that two different cations are components of a gel joined through chemical bonds. A dilute gel which flows easily on pouring is termed a sol. A supercritical fluid is defined as an element, compound or mixture above its critical temperature (T_{c}) or critical pressure (P_{c}) below which state changes can be effected by changes in temperature and/or pressure. We describe a silylating agent as a silicon containing compound under which, under the conditions used in our experiments, may act as a precursor to SiO₂ or react with Si—OH bonds. Calcination is defined as the removal of the organic template by thermal treatment in air. As an alternative, mixtures of air and ozone may be used for organic template removal.

The surfactant used may be, but is not limited to, one of the following: triblock copolymers of polyethylene (PEO), polypropylene (PPO), polyalkyloxide materials, triblock neutral surfactants having the general formula PEOxPPOyPEOz (e.g. Pluronic Materials from BASF, P127, P123, P65), diblock neutral copolymers having the general formula PEOₓPPO_{y} and polyoxyethylene alkyl ethers, e.g. CₓH₂ₓ₊₁—O—(CH₂—CH₂O)₂H e.g. Brij materials, Brij56, Brij55 available from Uniquema).

The alcohol-type solvent used may be, but is not limited to, one of the following, methanol, ethanol, propanol, butanol.

A suitable silating agent may be, but is not limited to, one of the following: tetraethoxysilane (TEOS), tetramethoxysilane (TMOS), tetrapropoxysilane (TPOS), and tetrabutoxysilane (TBOS), tetramethysilane, tetraethysilane.

A suitable titanating agent may be, but is not limited to a titanium alkoxide such as but not necessarily titanium tetra isopropoxide or titanium tetra isobutoxide.

The elemental oxide source used to prepare the sol may be, but is not limited to, an alkoxide or chloride of boron, lanthanum, and yttrium, titanium, or zirconium, silicon, tungsten, hafnium.

In one case the solution is deposited onto a substrate by spin coating the solution, which has been diluted with ethanol. Optimally, the solution is diluted to 50%, but may be diluted to other concentrations depending on the desired thickness of the final film. Ideally, the solution will be spin coated for 10 seconds at 100 rpm, then for 50 seconds at between 1000 and 5000 rpm, ramping the speed over 5 seconds. The result is a transparent, evenly coated film with no visible cracks (FIG. 4).

In another case dip coating can be used to coat the chosen substrate. Dip coating is normally carried out with an undiluted solution, where the substrates are immersed and withdrawn at 0.2 to 2 cm per minute. Optimally, the substrates are immersed and withdrawn at 0.5 cm/min. The solution can also be diluted with ethanol or another suitable solvent to control the thickness of the final film.

Control of the surfactant concentration used in the preparation of the elemental oxide mesoporous film allows the resulting pore structure of the film to be predetermined. Hexagonal and lamellar structures have parallel arrangements of pores and porous surfaces respectively. Cubic structures have channels running through the entire film that allow transport to and from the surface. This may be a desirable characteristic for a porous films used in adsorbent, catalysis or sensor devices and applications. Elemental oxide ordered mesoporous films are prepared in several stages and these are represented schematically in FIG. 1.

Step 1: In the first step a sol is prepared from a suitable chemical compound. This is a precursor to the inorganic framework of the mescoporous material. This compound must be hydrolysable so that a hydroxide species is formed. This hydroxide species should condense to form element-oxygen-element bonds. The precursor is mixed with the following ingredients: a suitable solvent which in most cases in an alcohol, a mixture of structural directing agents (surfactant templates), an acid hydrolysis catalyst, and controlled amounts of water. The sol may be prepared at temperatures between −5 and 80° C. The sol should be clear and free from any visible particles to produce high quality films. Of importance is the use of partial hydrolysis to make mesoporous materials of mixed cation composition. The amount of water and the temperature may be used to yield partially hydrolysed precursor compounds of one of the cations. Secondary precursors are then added to allow cross condensation and so produce mixed elemental oxide mesoporous materials. Adding a secondary alkoxide to the cooled solution allows the reaction of the secondary precursors to form a cross condensate via reactions such as:
—Al—OH+OH—Si— —Al—O—Si—+H₂O
This means that the element, for example, aluminium, is incorporated directly into the pore wall, which increases the mechanical strength and adhesion of the resulting mesoporous film.

Step 2: The sol produced in step 1 is allowed to stand for a period of time. This may be from one minute to several days and may be undertaken at temperatures between 0 and 80° C. The purpose of this process is to change the viscosity of the sol to allow film processing. The viscosity of the sol increases with time and temperature because of solvent evaporation and cross-linking of the inorganic polymer chains during the condensation processes. The sol may be diluted in a suitable alcohol to control the thickness of the film produced. The film may be most conveniently applied to substrates such as silicon, glass, alumina, silica etc. by spin or dip coating. For spin coating a measured drop of sol is placed at the centre of the substrate and spinning speeds of 50 to 10,000 revs min⁻¹ can be used. For dip coating the sample can be placed in the sol and removed at rates from 0.5 mm s⁻¹ to several cm s⁻¹. The sol is normally applied at temperatures between 0 and 40° C.

Step 3: The as spun or dipped film may require further treatment to allow densification of the inorganic walls and/or ordering of the inorganic-organic surfactant assembly (structural direction). This may involve secondary thermal processing of the as-coated films prepared as described in step 2. Solvent may be removed by drying for several hours or days at temperatures between 20 and 80° C. In cases where the sol does not have an ordered structure, during the evaporation of the solvent, the concentration of surfactant and inorganic constituents may become high enough to induce assembly of the ordered porous structure. Higher temperature treatments may or may not be required in a secondary stage. This allows pore walls to densify so that films survive the supercritical fluid treatment described below in step 4 and also to promote adhesion to the substrate. This treatment normally consists of heating at temperatures between 60° C. and 200° C.; the temperature should not be high enough to affect decomposition or degradation of the organic surfactant molecule.

Step 4: This is the supercritical fluid treatment and is responsible for achieving films or powders of very high thermal stability and exhibiting high degrees of ordered mesoporosity. The films described in step 3 are placed in a high pressure cell together with a controlled amount of a silating, titanating or similar agent and exposed to a fluid such that the pressure and temperature of the fluid are above the critical values. The sample may be heated to effect reaction at temperatures of up to 500° C. during this treatment. We believe that the high thermal stability of the supercritical fluid treated films can be ascribed to the dispersion of Si and its interactions with the mesoporous matrix. During the supercritical fluid silating treatment, the additional silicon species from the silating agent can penetrate into the rnesoporous wall structure of the films and occupy both surface and near-surface sites due to the high penetrating power of sc-CO₂ under high pressure. The interaction of Si species with mesoporous wall oxo-hydroxo oligomers will consequently lead to a compact and highly condensed wall which can resist further structural contraction when the film is calcined at a relatively high temperature. Thus, the densified wall of the post-treated film exhibits high thermal stability with no significant contraction of the pores during the high-temperature treatment.

Step 5: The substrate and films are removed from the supercritical fluid process conditions and further calcined at temperatures between 200 and 1000° C. for periods of a few minutes to several days in air or air/ozone mixtures to provide a films which consists of open pores (i.e. no organic surfactant present) and all the cationic species have been converted to oxides.

The invention will be more clearly understood by the following examples.

### EXAMPLE 1:

### Preparation of Mesoporous Titania Films

To make mesoporous titania films, a precursor solution was prepared using titanium tetra isopropoxide (Ti(i-PrO)₄, TTIP), a triblock copolymer surfactant of chemical formula given as EO₁₈PO₅₈EO₁₈, hydrochloric acid (HCl), and absolute ethanol (EtOH) with molar ratio of 1.0 TTIP: 0.02 surfactant: 2.0 HCl: 35.2 EtOH. A clear solution was obtained by stirring at room temperature for between 15 min and 3 hrs. The solution was dropped onto a silicon or glass substrate and the substrate was spun at 3110 rpm for 20 s. The resulting film was aged in air at ambient temperature at 60° C. for 24 hrs and then annealed at 150° C. for 48 hrs. For the preparation of treated films, the titania film on the substrate was placed in a 20 cm³ high-pressure cell with 0.02 cm³ of teramethyoxysilane (TMOS). The cell was attached via a three-way valve, to a stainless steel reservoir (21 cm³). A high-pressure pump (ISCO Instruments, PA) was used to pump CO₂ through the reservoir in to the reaction cell. The cell was placed in a furnace and heated to 300-500° C. and pressurised to 34.5-48.3 MPa simultaneously. The reaction proceeded at these conditions for about 15 minutes. The films were removed from the cell and calcined in a conventional furnace, in air at various temperatures for duration of one hour each. The surfactant is removed in this process by pyrolysis to yield an ordered mesoporous element silicate film. The resulting film has silicon, incorporated directly into the pore wall, which increases the thermal robustness of the film allowing subsequent process operations to be completed on the film without compromising the film's structural integrity.

In this preparation, by careful selection of the type and mixture of the surfactants used as well as the amount of each surfactants used, the pore size and structure can be varied.

### EXAMPLE 2

### Preparation of Mesoporous Zirconia Films

To make mesoporous zirconia films, a precursor solution was prepared using zirconium propoxide (Zr(PrO)₄) as a 70 wt % solution in n-propanol (PrⁿOH), a triblock copolymer surfactant of chemical formula given as EO₁₀₆PO₇₀EO₁₀₆, hydrochloric acid (HCl), and absolute ethanol (EtOH) with molar ratio of 1.0 Zr(PrO)₄: 0.0075 surfactant: 3 HCl: 35.2 EtOH: 2.4 PrⁿOH. A clear solution was obtained by stirring at room temperature for 3 hrs. The solution was dropped onto a silicon or glass substrate and the substrate was spun at 2500 rpm for 20 s. The resulting film was aged in air at ambient temperature at 60° C. for 12 hrs and then annealed at 150° C. for 24 hrs. For the preparation of treated films, the zirconia film on the substrate was placed in a 20 cm³ high-pressure cell with 0.02 cm³ of teramethyoxysilane (TMOS). The cell was attached via a three-way valve, to a stainless steel reservoir (60 cm³). A high-pressure pump (ISCO Instruments, PA) was used to pump CO₂ through the reservoir in to the reaction cell. The cell was pressurised to 48.3 MPa and then placed in a furnace and heated to 100° C. The reaction proceeded at these conditions for about 15 minutes. The films were removed from the cell and calcined in a conventional furnace, in air at various temperatures for duration of one hour each. The surfactant is removed in this process by pyrolysis to yield an ordered mesoporous zirconia film. The resulting film has silicon, incorporated directly into the pore wall, which increases the thermal robustness of the film allowing subsequent process operations to be completed on the film without compromising the film's structural integrity.

In this preparation, by careful selection of the type and mixture of the surfactants used as well as the amount of each surfactants used, the pore size and structure can be varied.

### EXAMPLE 3

### Preparation of Mesoporous Silica Films

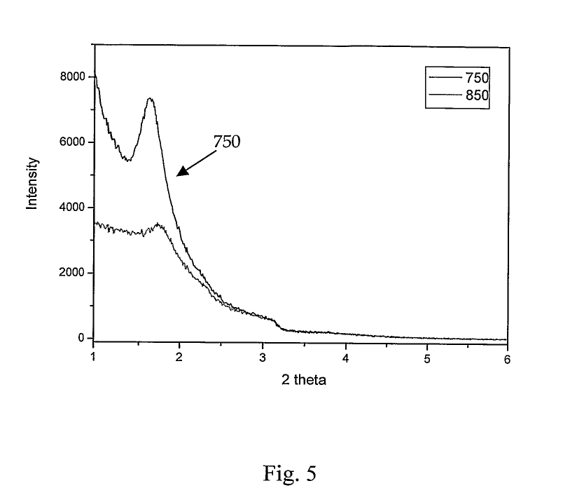

1.4 g of the triblock surfactant, indicated as EO₂₀PO₇₀EO₂₀, was added to 15 cm³ of absolute ethanol and stirred for one hour at 40° C. Then, 0.5 cm³ of 0.1 molar HCl was added. Following this, 5 cm³ of tetraethoxysilane (TEOS) and 0.5 cm³ of distilled water were added with vigorous stirring. These additions took place in about 5 minutes. The solution was stirred at room temperature for 3 hrs. The sol produced was then allowed to stand for 12-15 hours at room temperature to obtain the right viscosity of the sol to allow effective spin-coating. The obtained sol was diluted with an equal volume ethanol and then dropped onto a silicon substrate and then the substrate was spun as 3110 rpm for 20 seconds. The resulting film was aged in air at ambient temperature at 60° C. for 24 hrs and then annealed at 150° C. for 48 hrs. The films thus processed were treated in sc-CO₂ and TMOS as described above. The silica film on the substrate was placed in a 20 cm³ high-pressure cell with 0.02 cm³ of tetramethoxysilane (TMOS). The cell was placed in a furnace and heated to 300-500° C. and pressurized to 34.5-48.3 MPa simultaneously. The reaction proceeded at these conditions for about 15 minutes. The films were removed from the cell and calcined in a conventional furnace, in air at various temperatures for duration of one hour each. The surfactant is removed in this process by pyrolysis to yield an ordered mesoporous silica film. FIG. 5 illustrates the mesoporous structure of the film as a function of calcination temperature (used for pyrolysis) as indicated by PXRD. To temperatures of 750° C. the film exhibits a well-ordered mesoporous structure as indicated by the intense diffraction feature between 1.5 and 2° (two theta). It is only on heating to temperature of 850° C. does the film begin to show pore collapse. This degradation temperature is some 300° C. higher than for a non supercritical/TMOS treated sample.

The sol used to spin coat the substrate may be prepared in the following manner. 7 g of the triblock polymer surfactant indicated as C₁₆H₃₃(OCH₂CH₂)₁₀OH), was mixed directly with 13.5 cm³ of EtOH, 25 cm³ of TEOS and 2.5 cm³ of 0.12 molar hydrochloric acid. This was heated whilst stirring at 45° C. for 15 minutes. The mixture was then cooled in ice to 25° C. which effectively decreases the rate of hydrolysis of the silicon precursor so that the reaction is stable for several hours. 1 g of aluminium sec-butoxide was added and the mixture stirred for 10 minutes at a temperature of 25° C. Following the preparation the sol was allowed to stand for 24 hours at room temperature. Subsequently, a silicon substrate was coated as detailed above and processed with the sc-CO₂/TMOS treatment. Similar films with similar thermal robustness were prepared in this way. The only difference was that the mesoporous thin film silica had pores which were much closer together than for the triblock polymer surfactant prepared films. In this case, the change in pore-to-pore distance is related to the properties of the surfactant and not the process conditions.

### EXAMPLE 4

### Preparation of Mesoporous Titania Films

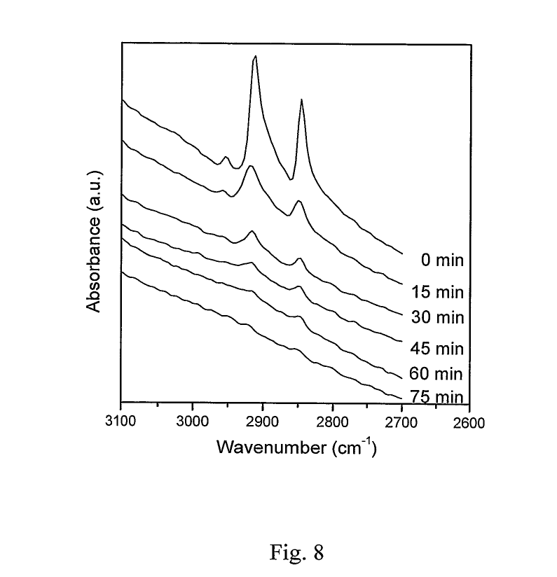

Mesoporous titania films were prepared exactly as defined in example 1 but were pre-treated using sc-CO₂ and titanium tetra isopropoxide (TTLP) and were demonstrated to have high photocatalytic activity. The films had very similar physical and structural properties as sc-CO₂ TMOS treated films but exhibited much better photocatalytic properties. The photocatalytic activity of the sc-CO₂ and TTIP pre-treated TiO₂ thin films was evaluated based on the decomposition of stearic acid in the following way. A 0.02 M solution of stearic acid in methanol was first coated on the titania-coated silicon wafers by a process of spin-coating. The silicon wafer was spun at 3100 rpm for 20 s at room temperature. The films were illuminated under UV light at a wavelength of 254 nm for various time intervals. The process of photocatalysis was evaluated by measuring the absorbance of the C-H vibration band of stearic acid in the wavelength range from 3100 to 2700 cm⁻¹. In this wavelength range stearic acid exhibits two strong and easily observed features. A sc-CO₂/TMOS treated film as prepared in example 1 was calcined at 550° C. for 1 hour prior to the photocatalysis experiment. IR spectra in the wavenumber range between 3100 and 2700 cm⁻¹ collected as a function of time during UV light irradiation and these show photodegradation of stearic acid by the sc-CO₂/TTIP treated thin film (FIG. 8). The C-H vibration band of stearic acid progressively disappears during illumination with UV light and after approximately 75 minutes the C-H peaks completely disappeared suggesting the total degradation of stearic acid. This degradation period is much faster than that observed from a similar titania film prepared without sc-CO₂ and TTIP pre-treatment.

In general, the invention involves forming an ordered mesoporous elemental oxide film using a supercritical fluid treatment. The invention provides a process to prepare films with greater thermal robustness than conventionally prepared materials and in certain cases alleviates significant experimental difficulties in the synthesis of the materials. The process is simple and can be widely applied. The process is not limited to particular surfactants or mixtures thereof and so the synthesis allows the control of the pore size and structure of the mesoporous film to be predetermined. Mesoporous films may be consistently formed by the process of the invention. The process may be used to prepare mixed mesoporous (i.e. containing more than one cation) oxide films using mixtures of precursors in the synthesis steps.

The mesoporous materials such as mesoporous thin films may be exploited as catalysts, including photocatalysts, absorbents and as dielectric materials in the semiconductor industry. Additionally, mesoporous thin films have potential applications as material components in highly specific chemical sensors, opto-electronic devices, chromatography support materials, thin-films for the glass sector, photovoltaics and fuel cells.

The present invention may be implemented with various changes and substitutions to the illustrated embodiments. For example, the present invention may be implemented on many different kinds of substrates other than silicon, such as, glass, quartz, sapphire, and alumina.

Although specific embodiments, including specific equipment, parameters, methods, and materials have been described, it will be readily understood by those skilled in the art and having the benefit of this disclosure, that various other changes in the details, materials, and arrangements of the materials and steps which have been described and illustrated in order to explain the nature of this invention may be made without departing from the principles and scope of this invention.

The invention is not limited to the embodiments hereinbefore described which may be varied in detail.

### REFERENCES

1. Cassiers, K. Linssen, T.; Meynen, V.; Voort, P. Van Der; Cool, P.; Vansant, E. F. Chem. Commun. 2003, 1178.
2. Grosso, D.; Soler-Illia,, G. J. de A. A.; Crepaldi, E. L.; Cagnol, F.; Sinturel, C.; Bourgeois, A.; Brunet-Bruneau, A.; Amenitsch, H.; Albouy, P. A. and Sanchez, C. Chem. Mater. 2003, 15, 4562.

1-48. (canceled)

49. A process for preparing a mesoporous material comprising the step of preparing a sol and treating the sol material under supercritical fluid conditions in the presence of a silating agent or a titinating agent.

50. The process as claimed in claim 49 wherein the treatment under supercritical fluid conditions forms an ordered mesoporous material.

51. The process as claimed in claim 49 wherein the mesoporous material is a mesoporous film.

52. The process as claimed in claim 49 wherein the mesoporous material is a mesoporous powder.

53. The process as claimed in claim 51 wherein the process comprises applying the sol to a substrate to form a mesoporous film and subsequently treating the film under supercritical fluid conditions.

54. The process as claimed in claim 52 wherein the process comprises directly treating the sol under supercritical fluid conditions to form a mesoporous powder material.

55. The process as claimed in claim 49 wherein the silating agent is selected from a silicon containing material which is decomposed to form silica during the supercritical fluid treatment.

56. The process as claimed in claim 55 wherein the silating agent is a silicon alkoxide or an organic silane.

57. The process as claimed in claim 56 wherein the silating is selected from any one or more of tetraethoxysilane (TEOS), tetramethoxysilane (TMOS), tetrapropoxysilane (TPOS), tetrabutoxysilane (TBOS), tetramethysilane, and tetraethysilane.

58. The process as claimed in claim 57 wherein the silating agent is a tetramethyloxysilane or tetramethylsilane.

59. The process as claimed in claim 49 wherein the titanating agent is titanium alkoxide.

60. The process as claimed in claim 49 wherein the titanating agent is titanium tetra isopropoxide or titanium tetra isobutoxide.

61. The process as claimed claim 49 wherein the supercritical fluid is selected from any one or more of carbon dioxide, propane, ethane, butane, pentane, hexane, ammonia and water.

62. The process as claimed claim 49 wherein the treatment is carried out at temperatures up to 500° C.

63. The process as claimed in claim 49 wherein the supercritical fluid treatment is carried out at a pressure greater than the critical pressure of the fluid and the temperature is less than 20° C. less than the critical temperature of the fluid.

64. The process as claimed in claim 49 wherein after treatment with supercritical fluid the mesoporous material is calcined in air or air-ozone mixtures at temperatures between 200 and 1000° C.

65. The process as claimed in claim 49 wherein the sol comprises a surfactant template, an elemental oxide precursor inorganic compound, a catalyst, and a solvent.

66. The process as claimed in claim 65 wherein the precursor inorganic compound is a hydrolysable compound as the source of cations in the final mesoporous oxide framework.

67. The process as claimed in claim 65 wherein the precursor compound is a compound selected from any one or more of Si, Al, Ti, B, La, Zr, Hf, Y and W.

68. The process as claimed in claim 65 wherein the precursor compound is an alkoxide.

69. The process as claimed in claim 65 wherein the precursor compound is a chloride.

70. The process as claimed in claim 65 wherein the solvent is an alcohol.

71. The process as claimed in claim 70 wherein the alcohol is selected from one or more of ethanol, methanol, 1-propanol, 2-propanol and 1-butanol.

72. The process as claimed in claim 65 wherein the catalyst is an acid catalyst.

73. The process as claimed in claim 72 wherein the acid is selected from one or more of hydrochloric, nitric, sulfuric, phosphoric, hydrofluoric, acetic and citric acid.

74. The process as claimed in claim 65 wherein the surfactant is selected from the group consisting of triblock copolymers of polyethylene (PEO), polypropylene (PPO), polyalkyloxide materials, polyoxyethylene alkyl ethers and anionic or cationic surfactants consisting of alkyl chains and ionic head groups such as cetyl trimethyl ammonium bromide.

75. The process as claimed in claim 49 wherein the sol is prepared by heating the sol mixture to a temperature between −4° C. and 80° C. for up to 2 hours.

76. The process as claimed in claim 49 further comprising cooling the sol and controlling the amount of water to a temperature between −4° C. and 25° C. to effect the production of a partially hydrolysed product prior to adding a secondary inorganic precursor compound to effect cross condensation.

77. The process as claimed in claim 49 wherein the prepared sol is allowed to stand for a period at a temperature between 0° C. and 80° C.

78. The process as claimed in claim 49 wherein the sol material is applied to a substrate by spin or dip coating.

79. The process as claimed in claim 49 wherein the film is dried in defined stages at temperatures between 20 and 200° C.

80. The process as claimed in claim 65 comprising selecting the surfactant to control the pore size of the mesoporous material.

81. The process as claimed in claim 49 comprising selecting the pressure of the supercritical fluid and the temperature thereof to control the pore size of the mesoporous material.

82. The ordered mesoporous material whenever prepared by a process as claimed in claim 49.

83. A mesoporous material having an ordered array of parts with a pore diameter of between 1 and 30 nm.

84. The mesoporous material as claimed in claim 83 wherein the pore diameter is between 1 and 15 nm.

85. The mesoporous material as claimed in claim 83 wherein the pore diameter is between 1 and 5 nm.

86. The mesoporous material as claimed in claim 83 in the form of a film.

87. The mesoporous material as claimed in claim 83 in the form of a powder.

88. The mesoporous material as claimed in claim 83 formed by an elemental oxide.

89. Use of a mesoporous material as claimed in claim 84 as catalysts, photocatalysts, absorbents, dielectric materials, chemical sensors, opto-electronic devices, chromatography support materials, thin-films for the glass sector, photovoltaics and fuel cells.
